(19) United States
(12) Patent Application Publication
(10) Pub. No.: US 2012/0133678 A1
(43) Pub. Date: May 31, 2012

(54) APPARATUS AND METHOD FOR CONTROLLING SCREEN CONVERSION IN PORTABLE TERMINAL

(75) Inventor: Ho-Gon KIM, Gyeonggi-do (KR)

(73) Assignee: SAMSUNG ELECTRONICS CO., LTD., Gyeonggi-Do (KR)

(21) Appl. No.: 13/306,034

(22) Filed: Nov. 29, 2011

(30) Foreign Application Priority Data
Nov. 30, 2010 (KR) 10-2010-0120813

(51) Int. Cl. G06F 3/041

(52) U.S. Cl. 345/649

(57) ABSTRACT

Provided is an apparatus and method for controlling the screen conversion mode in a portable terminal based on the intended action of a user. The screen conversion function of the portable terminal is selectively disabled based on predetermined criteria so that a pre-movement screen direction of the portable terminal is maintained upon detecting a movement of the portable terminal.

CLAM OF PRIORITY

This application claims the benefit under 35 U.S.C. §119(a) of a Korean Patent Application filed in the Korean Intellectual Property Office on Nov. 30, 2010 and assigned Serial No. 10-2010-0120813, the entire disclosure of which is hereby incorporated by reference.

### BACKGROUND OF THE INVENTION

1. Field of the Invention

The present invention relates generally to an apparatus and method for controlling a conversion of the screen in a portable terminal, and more particularly, to an apparatus and method for controlling screen conversion in a portable terminal through an action of a user.

2. Description of the Related Art

Recently, portable terminals have evolved to provide a high-rate data communication function as well as a voice communication function. For example, in the IMT-2000 mobile communication network, the portable terminal can perform such data and voice communication. Examples of the data processible by the portable terminal include packet data and video data.

Also, the portable terminal is readily equipped with a camera or a TV receiver to provide a video signal display function. The portable terminal with a camera can capture/display moving pictures and still pictures and can transmit the captured pictures. The portable terminal with a TV receiver can display received video signals.

Further, the portable terminal typically has a screen conversion control function so that video signals are always displayed in fixed direction regardless of the movement direction of a portable terminal.

The screen conversion control function serves to display video signals in the normal direction continuously by converting and adjusting the screen according to the movement direction of the portable terminal. However, the screen conversion operation can perform automatically even when the user does not want it.

For example, if the user lies while holding the portable terminal, the screen conversion control function detects the movement of the portable terminal and inadvertently performs a screen conversion operation during some movement.

### SUMMARY OF THE INVENTION

An exemplary embodiment of the present invention is to provide an apparatus and method for selectively controlling the screen conversion in a portable terminal through an action of a user.

According to an aspect of the present invention, an apparatus for controlling screen conversion in a portable terminal includes: a touchscreen unit; and a control unit for disabling a screen conversion function of the portable terminal and controlling the touchscreen unit to maintain a pre-movement screen direction of the portable terminal, when detecting a movement of the portable terminal during an occurrence of an action at the portable terminal.

According to another aspect of the present invention, a method for controlling screen conversion in a portable terminal includes: disabling a screen conversion function of the portable terminal when detecting a movement of the portable terminal during an occurrence of an action at the portable terminal; and performing a relevant function while maintaining a pre-movement screen direction of the portable terminal by disabling the screen conversion function.

According to an aspect of the present invention, a mobile terminal for selectively controlling a screen orientation includes: a touchscreen unit; and a control unit for enabling and disabling a screen conversion function of the terminal when detecting a movement of the terminal, wherein the screen conversion function is disabled when the touch screen is being touched during the movement of the terminal or when a pressured is applied to the terminal.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention;

FIG. 2 is a flow diagram illustrating a process for controlling screen conversion in a portable terminal according to an exemplary embodiment of the present invention;

FIGS. 3A and 3B are diagrams for describing the process of FIG. 2;

FIG. 4 is a flow diagram illustrating a process for controlling screen conversion in a portable terminal according to another exemplary embodiment of the present invention; and

FIGS. 5A and 5B are diagrams for describing the process of FIG. 4.

### DETAILED DESCRIPTION OF THE INVENTION

Exemplary embodiments of the present invention will be described below in detail with reference to the accompanying drawings. Like reference numerals in the drawings denote like elements. The present invention may, however, be embodied in different forms and should not be construed as limited to the embodiments set forth herein; rather, these embodiments are provided so that this disclosure will be thorough and complete, and will fully convey the scope of the present invention to those skilled in the art.

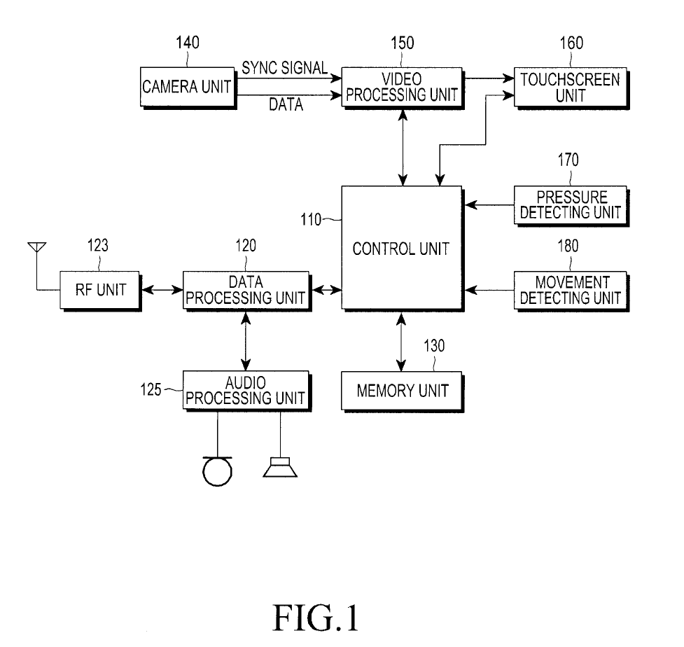

FIG. 1 is a block diagram of a portable terminal according to an exemplary embodiment of the present invention.

Referring to FIG. 1, a portable terminal according to an exemplary embodiment of the present invention includes a control unit 110, a data processing unit 120, a radio frequency (RF) unit 123, an audio processing unit 125, a memory unit 130, a camera unit 140, a video processing unit 150, and a touchscreen unit 160, a pressure detecting unit 170, and a movement detecting unit 180.

In operation, the RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The memory unit 130 may include a program memory and a data memory. The program memory may store programs for controlling a general operation of the portable terminal, and programs for disabling a screen conversion function when the portable terminal moves during the occurrence of an action at the portable terminal.

The control unit 110 controls an overall operation of the portable terminal.

According to an exemplary embodiment, when detecting a movement of the portable terminal during the occurrence of an action at the portable terminal with the screen conversion function enabled, the control unit 110 disables the screen conversion function and controls the touchscreen unit 160 to maintain the pre-movement screen direction of the portable terminal.

According to an exemplary embodiment, the control unit 110 determines the occurrence of a movement of the portable terminal by a movement detection signal received from the movement detecting unit 180.

According to an exemplary embodiment, when detecting a movement of the portable terminal during the occurrence of a touch to the touchscreen unit 160 in the portable terminal, the control unit 110 disables the screen conversion function and controls the touchscreen unit 160 to maintain the pre-movement screen direction of the portable terminal.

According to another exemplary embodiment, when detecting a movement of the portable terminal during the application of a pressure to the portable terminal, the control unit 110 disables the screen conversion function and controls the touchscreen unit 160 to maintain the pre-movement screen direction of the portable terminal.

According to another exemplary embodiment, the control unit 110 determines the application of the pressure to the portable terminal according to a pressure detection signal received from the pressure detecting unit 170.

According to an exemplary embodiment, when detecting a movement of the portable terminal while the touchscreen unit 160 performs a relevant function and while maintaining the pre-movement screen orientation of the portable terminal, the control unit 110 enables the screen conversion function.

The touchscreen unit 160 displays video signals outputted from the video processing unit 150, and displays user data outputted from the control unit 110. The touchscreen unit 160 may operate as a display unit and an input unit. When operating as an input unit, the touchscreen unit 160 may display keys for inputting numeral and character information and function keys for setting various functions.

According to another exemplary embodiment, the pressure detecting unit 170 may be a pressure sensor that detects the application of a pressure to the portable terminal. The pressure detecting unit 170 may be disposed at each of both sides or each of top and bottom sides of the portable terminal. When a pressure is applied to both sides or top and bottom sides of the portable terminal, the pressure detecting unit 170 detects the pressure and transmits a pressure detection signal to the control unit 110.

According to an exemplary embodiment, the movement detecting unit 180 may be an acceleration sensor or a gravity sensor that detects the occurrence of a movement of the portable terminal. When the portable terminal moves, the movement detecting unit 180 detects the movement and transmits a movement detection signal, which indicates the movement occurrence and the movement direction, to the control unit 110.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

The video processing unit 150 performs an image signal processing (ISP) operation to display video signals, outputted from the camera unit 140, on the touchscreen unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the touchscreen unit 160. Also, the video processing unit 150 includes a video codec to compress the frame video data displayed on the touchscreen unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

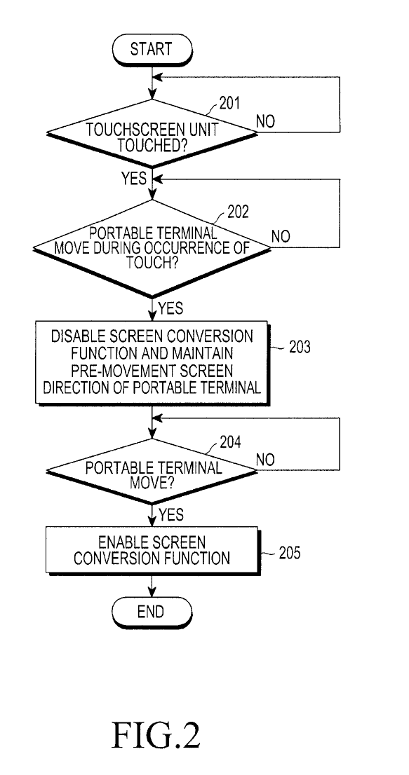

A process for controlling screen conversion in the portable terminal according to exemplary embodiments of the present invention will be described below in detail with reference to FIGS. 2 to 5.

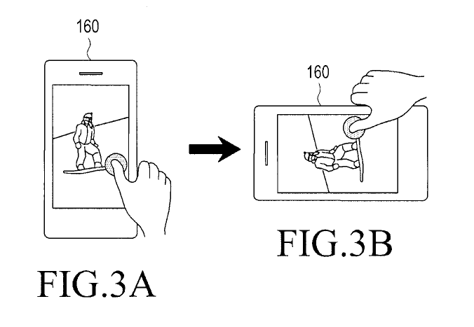

FIG. 2 is a flow diagram illustrating a process for controlling screen conversion in the portable terminal according to an exemplary embodiment of the present invention. FIGS. 3A and 3B are diagrams for describing the process of FIG. 2.

Referring to FIGS. 1 and 2, in step 201, the control unit 110 determines whether a predetermined region of the touchscreen unit 160 is touched during the execution of a predetermined mode (e.g., a message mode, a messenger mode, or an image display mod) in the portable terminal when the screen conversion function enabled. If a predetermined region of the touchscreen unit 160 is touched during the execution of a predetermined mode in the portable terminal, the control unit 110 proceeds to step 202.

In step 202, the movement detecting unit 180 detects whether the portable terminal moves during the occurrence of a touch to the touchscreen unit 160. If so, the movement detecting unit 180 transmits a movement detection signal to the control unit 110. Upon receiving the movement detection signal from the movement detection unit 180, the control unit 110 proceeds to step 203.

In step 203, the control unit 110 disables the screen conversion function.

Also, in step 203, the control unit 110 controls the touchscreen unit 160 to perform a relevant function while maintaining the pre-movement screen direction of the portable terminal regardless of the movement of the portable terminal.

In step 204, the movement detecting unit 180 detects whether the portable terminal moves thereafter. If so, the movement detecting unit 180 transmits a movement detection signal to the control unit 110. Upon receiving the movement detection signal from the movement detection unit 180, the control unit 110 proceeds to step 205.

In step 205, the control unit 110 enables the screen conversion function.

The above process is visually illustrated in FIG. 3. When the portable terminal moves to a horizontal mode as illustrated in FIG. 3B while a predetermined region of the touchscreen unit 160 is touched in a vertical mode of the portable terminal as illustrated in FIG. 3A, the screen conversion function is disabled to maintain the direction of the screen displayed in the vertical mode of the portable terminal.

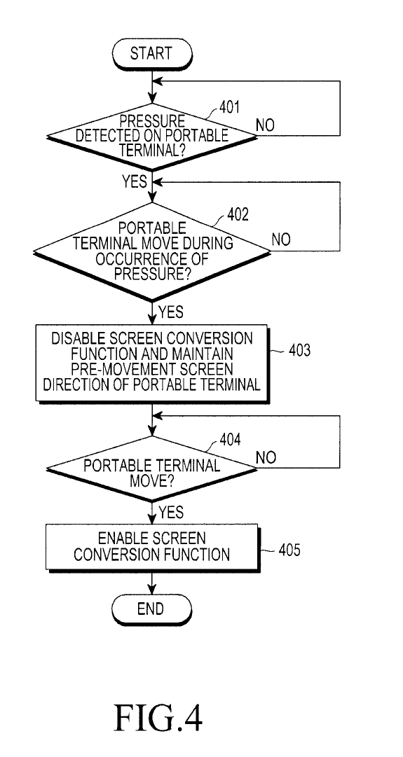

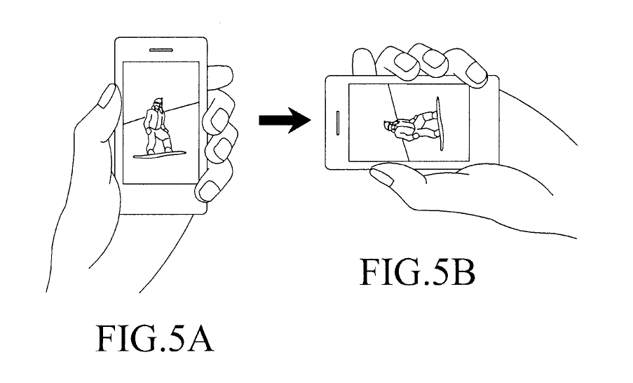

FIG. 4 is a flow diagram illustrating a process for controlling screen conversion in the portable terminal according to another exemplary embodiment of the present invention. FIGS. 5A and 5B are diagrams for describing the process of FIG. 4.

Referring to FIGS. 1 and 4, in step 401, the pressure detecting unit 170 detects whether a pressure is applied to both sides or top and bottom sides of the portable terminal during the execution of a predetermined mode (e.g., a message mode, a messenger mode, or an image display mod) in the portable terminal when the screen conversion function enabled. If a pressure is applied to both sides or top and bottom sides of the portable terminal during the execution of a predetermined mode in the portable terminal, the pressure detecting unit 170 transmits a pressure detection signal to the control unit 110.

Upon receiving the pressure detection signal from the pressure detection unit 170, the control unit 110 proceeds to step 402.

In step 402, the movement detecting unit 180 detects whether the portable terminal moves during the application of a pressure to both sides or top and bottom sides of the portable terminal. If so, the movement detecting unit 180 transmits a movement detection signal to the control unit 110. Upon receiving the movement detection signal from the movement detection unit 180, the control unit 110 proceeds to step 403.

In step 403, the control unit 110 disables the screen conversion function.

Also, in step 403, the control unit 110 controls the touchscreen unit 160 to perform a relevant function while maintaining the pre-movement screen direction of the portable terminal regardless of the movement of the portable terminal.

In step 404, the movement detecting unit 180 detects whether the portable terminal moves thereafter, and if so, the movement detecting unit 180 transmits a movement detection signal to the control unit 110. Upon receiving the movement detection signal from the movement detection unit 180, the control unit 110 proceeds to step 405.

In step 405, the control unit 110 enables the screen conversion function.

The above process is visually illustrated in FIG. 4. When the portable terminal moves to a horizontal mode as illustrated in FIG. 5B while a pressure is applied by the user to both sides of the portable terminal with the pressure detecting unit 170 in a vertical mode of the portable terminal as illustrated in FIG. 5A, the screen conversion function is disabled to maintain the direction of the screen displayed in the vertical mode of the portable terminal.

As described above, the present invention provides an apparatus and method for controlling screen conversion in a portable terminal, thereby making it possible to simply disable a screen conversion function of the portable terminal when the user does not want the screen conversion function.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for controlling a screen orientation of a portable terminal, comprising:
a touchscreen unit; and
a control unit for selectively disabling a screen conversion function of the portable terminal in order to maintain the screen orientation when detecting a movement of the portable terminal during an occurrence of a predetermined action.

2. The apparatus of claim 1, wherein the predetermined action occurs when the screen conversion function of the portable terminal is enabled.

3. The apparatus of claim 1, wherein the predetermined action is a touch to the touchscreen unit or applying a pressure on the portable terminal.

4. The apparatus of claim 1, further comprising a pressure detecting unit for detecting a pressure on the portable terminal.

5. The apparatus of claim 4, wherein the pressure detecting unit is disposed at both sides or top and bottom sides of the portable terminal.

6. The apparatus of claim 1, wherein the control unit enables the screen conversion function when detecting a movement of the portable terminal while the screen conversion function is disabled.

7. A method for controlling a screen orientation in a portable terminal, comprising:
disabling a screen conversion function of the portable terminal when detecting a movement of the portable terminal during an occurrence of a predetermined action on the portable terminal; and
performing a relevant function while maintaining the screen orientation of the portable terminal when the screen conversion function is disabled.

8. The method of claim 7, wherein the predetermined action occurs when the screen conversion function of the portable terminal is enabled.

9. The method of claim 7, wherein the predetermined action is a touch to the touchscreen unit or applying a pressure on the portable terminal.

10. The method of claim 9, wherein the pressure is detected at both sides or top and bottom sides of the portable terminal.

11. The method of claim 7, further comprising:
enabling the screen conversion function when detecting a movement of the portable terminal while the screen conversion function is disabled.

12. A mobile terminal for selectively controlling a screen orientation, comprising:
a touchscreen unit; and
a control unit for enabling and disabling a screen conversion function of the terminal when detecting a movement of the terminal, wherein the screen conversion function is disabled when the touch screen is being touched during the movement of the terminal or when a pressured is applied to the terminal.

13. The terminal of claim 12, further comprising a pressure detecting unit for detecting the pressure applied on the terminal.

14. The terminal of claim 13, wherein the pressure detecting unit is disposed at both ends of the terminal.

15. The terminal of claim 12, wherein the control unit enables the screen conversion function after the screen conversion function is disabled upon detecting another movement of the terminal.
